(19) United States
(12) Patent Application Publication
(10) Pub. No.: US 2026/0346570 A1
(43) Pub. Date: Nov. 5, 2026

(54) DOUBLE-DOUBLE LAMINATE STRUCTURES WITH REDUCED LENGTH FIBER(S) AND METHODS FOR MANUFACTURING AND USING THE SAME

(71) Applicant: The Board of Trustees of the Leland Stanford Junior University, Stanford, CA (US)

(72) Inventor: Stephen W. Tsai, Honolulu, HI (US)

(21) Appl. No.: 19/668,296

(22) Filed: May 5, 2026

Related U.S. Application Data
(60) Provisional application No. 63/800,004, filed on May 5, 2025.

(51) Int. Cl. B32B 7/03; B32B 1/00; B32B 5/26; B32B 38/00; B32B 43/00

(52) U.S. Cl. CPC B32B 7/03; B32B 1/00; B32B 5/26; B32B 38/0012; B32B 43/003; B32B 2038/0028; B32B 2262/16; B32B 2307/514; B32B 2603/00; B32B 2605/08; B32B 2605/18

(57) ABSTRACT

Described herein is a sub-laminate module for use in forming a composite laminate structure. A plurality of sub-laminate modules are used to form a composite laminate structure. Each of the plurality of sub-laminate modules comprise a set of ply layers having a plurality of plies contained therein and oriented at different angles relative to a longitudinal axis of each of the plurality of sub-laminate modules, wherein at least a portion of the plurality of plies have a length that is shorter than a length of conventional plies in a correspondingly structured module. Associated methods for forming the composite laminate structure are also disclosed.

### CROSS REFERENCE TO RELATED APPLICATIONS

This application claims priority to and the benefit of U.S. Provisional Application No. 63/800,004, filed May 5, 2025; the contents of which are hereby incorporated by reference in their entirety

### BACKGROUND

### Technical Field

Various embodiments of the present invention relate generally to composite laminate structures, in particular those containing reduced length fiber(s), together with methods of manufacturing, selecting, and using such structures.

### Description of Related Art

Conventional composite laminate structures were generally designed to emulate the strength characteristics of conventional metal-based laminate materials and as such are constrained to designs having layers of plies that are both symmetrical and balanced. Such conventional structures, when so constrained and containing at least four distinct ply layers formed from black carbon fibers, were commonly referred to in the art as “black aluminum” due to their combined carbon makeup and metal-emulating characteristics. Additional details surrounding conventional composite laminate structures may be understood with reference to US Publication No. 2006/0093802, the contents of which as are hereby incorporated herein by reference in their entirety.

These conventional composite laminate structures oftentimes utilized “legacy quad laminates” (as commonly referred to), which involve laminates made of collections of [0], [±45] and plies (see e.g., legacy quad field 1, illustrated in FIG. 1A and detailed elsewhere herein). When one each of the three layers is stacked, the resulting structure is quasi-isotropic because it matches the isotropic properties of aluminum, which informs one of the reasons for calling such composite laminate black aluminum. The legacy quad laminates were always discrete in nature, meaning a limited number of ply angles and/or ply angle combinations (of multiple layers of the four discrete plies, as listed above) could be chosen. To have desired directional properties, more plies than the quasi-isotropic made of four plies had to be added, leading to 6, 8, 10 or more plies of sub-laminates (as detailed elsewhere herein). When laminates are made with mid-plane symmetry, resulting total laminates have doubled thickness of 12, 16, and 20 plies. If thicker laminates are needed, multiples of 12, 16, and 20 had to be considered. In extreme cases, laminates are selected based on total laminate without use of sub-laminates. In such cases, the total laminate may be selected based on the percentages of 0°, ±45° and 90° with plies dispersed across the thickness. Only explicit requirements in such cases are mid-plane symmetry, and a limit of three on-ply orientation groupings (i.e., no more identical ply groupings can be stacked together).

The above is a unique issue with the legacy quad family of laminates. First, the sub-laminates are thick, secondly, mid-plane symmetry is required, and, lastly, huge jump in laminate thickness as thick sub-laminates are added. The huge jump can be mitigated by adding some chosen plies not part of the repeated sub-laminates. But such arbitrarily added plies, in thickness less than 6, 8, or 10 plies, differ from the properties of the sub-laminates and make optimization practically impossible. There is also an issue on minimum gauge. Many components and devices require laminate thickness less than 12, 16, and 20 plies. The use of legacy quad composites is thus not feasible in those contexts, such as for example in the realm of fuselage or wing skins. Sub-laminates of this nature were also delamination prone, and multiple failure modes resulting from thousands of fiber discontinuities and matrix cracking. Complex procedures to blend adjacent laminates with different stacking and thickness, and to drop or add plies are required for a complex structure and impede optimization and manufacturing.

With reference now to FIG. 1B, relative to the 10-ply legacy quad field 1 illustrated in FIG. 1A, populated therein also are the discrete sub-laminates achievable (indicated by the discrete dots or anchors shown) with not only a 10-ply sub-laminate, but also with associated 6-ply and 8-ply configurations (i.e., a combined 10-, 8-, and 6-ply configuration 5). Thus, it may be understood that—even with the 6-, 8-, and 10-ply conventional legacy quad sub-laminate structures—a total field of only forty-seven (47) laminates was achievable (see again, FIG. 1B; see also FIG. 3B). Notably, though, holes remain visible between the respective discrete sub-laminate structures (i.e., although some of the dots or anchors 6 may partially overlap one another, not all of the dots or anchors 6 fully overlap with each other and thus fill all of the visible space in the field); as a result, achieving certain desirable material characteristics remains challenging and many times simply unachievable (again, due to the various self-inflicted constraints on conventional legacy quad field sub-laminates having different thicknesses in 6 to 10-plies that make blending and ply drop so complicated).

Inefficiencies arose in conventional composite laminate structures due to their discrete nature, exacerbated by self-inflicted constraints in the industry, including a perceived requirement that all composite laminate structures—and in particular the sub-laminate structures therein—have balanced and symmetric material characteristics; stated otherwise, they involve necessarily thick sub-laminate structures and mid-plane symmetry. Specifically, symmetric laminates involve a reflective or mirror-image equivalence of ply orientation about their mid-plane, while balanced laminates involve an equal number of positively (+) and negatively (−) oriented plies across their entirety. Such constraints have historically largely remained unchallenged due to concerns that conventional composite laminated structures will undesirably warp upon cool down from a curing temperature or increased residual stress when the operating temperature changes. For example, to enforce symmetry, a minimum number of plies must be doubled leading to 12, 16, and 20 plies, or higher multiples like 24, 32 and 40, and beyond. Additional details surrounding conventionally imposed constraints may be understood with reference to U.S. Pat. No. 9,296,174, the contents of which as are hereby incorporated herein by reference in their entirety.

Symmetric laminates have been traditionally formed by stacking the multiple layers of various unidirectional plies in such a manner that the composite laminate exhibits a mirror-image of itself about a mid-plane of the structure. Such lamination processes are generally time and labor intensive as well as being prone to error, requiring special attention to ensure precision ordering of the respective composite layers and may result in an unnecessary number of plies, which may contribute to excessive process waste and cost. Still further symmetric laminates have historically proven cumbersome when seeking to taper the exterior surface of a structure, due at least in part to the desire to maintain symmetry throughout, even when dropping ply layers to form the taper. In addition, as the individual or a pair of symmetric plies with substantially the same orientation is dropped to form a taper, the laminate stacking sequence and thus the material's strength characteristics, are altered.

Although not problematic on their own, balanced laminates, like symmetric ones described above, have been traditionally formed by stacking multiple layers of various unidirectional plies at a plurality of precise orientations with relatively large angles between them. For example, each off-axis ply, such as a +45° ply is typically matched (e.g., mirrored) by a −45° ply. In addition, a common practice was to have four-ply orientations incorporating angles of −45°, 0°, +45°, and 90° (i.e., the [0], [±45] and configuration mentioned previously herein, simply using an alternative nomenclature). Three-ply orientations were also common, such as 0°, ±45° configurations; yet critical was that the number of positive (+) and negative (−) oriented plies remain equal.

Balanced and symmetric laminates of this nature have also traditionally created difficulty when trying to minimize laminate and even sub-laminate thickness, requiring ever thinner plies as the only option to offset the need to add 6-, 8- or 10-ply (or even more plies such as being doubled when symmetry is required) to achieve desirable material characteristics. Tapering (i.e., ply drop) complexities have also existed in these structures as well, with one exemplary limitation being that dropping of specific plies or groups thereof must not disturb the desired symmetry and balance. As a result, due to the discrete nature of available ply angles (influenced by both the extra thick sub-laminate structures and the symmetry constraints detailed herein), there were necessarily gaps between achievable laminate stiffness and/or strength characteristics that simply could not be bridged. Multiple failure modes, thousands of fiber discontinuities from ply drops and results from blending, and complexity in manufacturing were thus often faced due to self-inflicted constraints; stated otherwise, an optimal set of material characteristics in a laminate structure oftentimes had to be sacrificed to satisfy various self-imposed constraints; as a result less than optimal laminate structures were used.

Improving upon conventional balanced and symmetric laminates, a continuous double-double sub-laminate structure was initially developed, as illustrated in FIGS. 2A-C. With reference now first to FIG. 2B, therein are illustrated respective fields 30/35 for double-double helix laminate structures. In the left-hand chart of tabular data, there is illustrated according to various embodiments, from 0 to 90 degrees and in 10° increments, the continuous double-double sub-laminate field 30. Stated otherwise, in being continuous every value can be met; there are no holes. As may be understood, by comparison to FIG. 1B (illustrating the legacy quad laminate discrete members), many more options are provided and in a manner that provides a truly continuous field of variables from which to select for construction of any particular element for a structural component or the like.

In the right-hand chart of FIG. 2B, the tabular data also illustrates, from 0 to 90 degrees and in 2° increments, a further granular level of an achievable continuous double-double sub-laminate field 35. It should be understood that this field is achieved in substantially the same manner as the continuous field 30 described above and also illustrated in FIG. 2B, but for the degree of granularity in field 35 being at increments of 2° between each ply within the sub-laminate structure. The result, as illustrated, is a collection 35 (by way of non-limiting example) that includes 2,116 continuous laminates 36 that may all be utilized for forming a desired sub-laminate structure. Notably, a continuous field is provided, as compared with the limited set of discrete members provided in conventional configurations. For many devices high precision in stiffness may be required. They include acoustic and high frequency situations which often require such precision.

FIG. 2C further illustrates the manner in which the degree of granularity involved in forming each collection of continuous double-double sub-laminates was expansive, whereby here there is illustrated a continuous field 40 (see right-hand chart), produced with angle increments of 1°. This field results, as illustrated in the right-hand chart of FIG. 2C, in a double-double laminate field 40 that contains 8,281 sub-laminate structures from which to choose, each having distinctive material characteristics associated therewith. It should be understood that the illustrated angle increments in these figures(e.g., 10°, 2°, 1°) are non-limiting examples; in view of the derivative nature of the double-double sub-laminate field (as detailed elsewhere herein), any angle increment can be selected, depending upon the degree of granularity that may be necessary to obtain a viable stiffness or strength match (as also detailed elsewhere herein) to a conventional laminate structure and/or sub-laminate structure. In this manner, the double-double sub-laminate fields 30, 35, 40 should be understood as indicative of a continuous field of selectable ply angle and ply layer configurations, so as to best match conventional laminate structures having much greater thicknesses and/or to fill gaps of strength or stiffness values in such conventional structures due to the limited set of 47 discrete values under legacy quad-type configurations, as described previously herein.

Returning now to FIG. 2B, various advantages of the previously developed double-double field 30, 35 (depending on incremental degree chosen) may be understood. First, a continuous field of laminates [±Φ/±Ψ] (see FIG. 2C as well, illustrating the discrete and independent [±Φ] 42 and [±Ψ] 41 ply angle sets) is provided for selection therefrom, as contrasted with the discrete legacy quad collections (i.e., 47 options versus double-double's 8,281+potential options). Zooming to achieve higher resolution (i.e., granularity) is conceptually easy via various embodiments of the double-double sub-laminate described herein and is shown on the right side of FIG. 2B. Equally important with granularity and this continuous field is the advantage that the sub-laminate thickness remains constant, at most being 4-ply; 2- or 1-ply configurations. Stiffness values may thus be also changed in a continuous fashion (i.e., no holes or gaps), simply by changing the angles within the continuous field, as may be understood with reference to FIG. 2A. This makes optimization possible, blending by changing one helix at a time feasible (as described elsewhere herein), and out-of-plane homogenization more easily achieved (as also described elsewhere herein). All these features—not available from the legacy quad-type structures—via the various embodiments described herein are now achievable, leading to stronger, tougher, fewer failure modes, lighter, lower cost structure, not to mention lower minimum gage, with natural mid-plane symmetry, and feasible automated layup.

Referring now also to FIG. 2A, therein is illustrated a chart of stiffness values 25 for the previously developed double-double laminate structures, illustrating the continuous field provided thereby, dependent upon the ply angle values [±Φ/±Ψ] of the double-double sub-laminate. For example, a double-double sub-laminate having four total plies of [±Φ=20°/±Ψ=60°] would have a stiffness value of 0.410. Stiffness values of each possible combination in the double-double sub-laminate field (see e.g., fields 30, 35, 40 of FIGS. 2B-C) are influenced (i.e., changed) by changing the angles of each pair of plies within each angle set (i.e., two sets within each sub-laminate, as will be detailed elsewhere herein). Notably, there within the previously developed structure 50% of each of ±Φ and ±Ψ. This provided a degree of simplicity, as compared to legacy quad members, where differing percentages of each angle must be utilized to alter stiffness values.

The present invention relates generally to certain applications of double-double composite laminates and/or construction and/or utilization of the double-double composite laminates in a manner involving short or reduced length fibers therein, which specifics have been observed to provide desirable material characteristics comparable to conventional composite laminates without the restrictions and/or additional thickness, weight, and/or restrictions required therefor.

### BRIEF SUMMARY

Various embodiments of the present invention are directed toward a sub-laminate module for use in forming a composite laminate structure. The sub-laminate module comprises: a set of ply layers having a plurality of plies contained therein and oriented at different angles relative to a longitudinal axis of each of the plurality of sub-laminate modules, wherein at least a portion of the plurality of plies have a length that is shorter than a length of conventional plies in a correspondingly structured module.

Various embodiments of the present invention are also directed toward a composite laminate structure comprising: a plurality of sub-laminate modules. Each of the sub-laminate modules comprises: a set of ply layers having a plurality of plies contained therein and oriented at different angles relative to a longitudinal axis of each of the plurality of sub-laminate modules, wherein at least a portion of the plurality of plies have a length that is shorter than a length of conventional plies in a correspondingly structured module.

Various embodiments of the present invention are directed toward a method of manufacturing a sub-laminate module for use in forming a sub-laminate module, the method comprising the step of cutting a portion of a plurality of plies to a shortened length.

### BRIEF DESCRIPTION OF SEVERAL VIEW OF THE DRAWINGS

Brief reference will now be made to the accompanying drawings, which are not necessarily drawn to scale and wherein:

FIG. 1A, representative of prior art, shows a legacy quad conventional sub-laminate family, with focus upon a 10-ply configuration;

FIG. 1B, representative of prior art, shows the legacy quad conventional sub-laminate family of FIG. 1A, incorporating further 8- and 6-ply configurations alongside the 10-ply configuration;

FIG. 1C shows one stiffness component of a subset of the 47 sub-laminates within the legacy quad conventional family of FIGS. 1A-B;

FIG. 2A shows final stacking of a wing structure according to conventional configurations;

FIG. 2B shows discrete sub-laminate components or elements of a fuselage according to conventional configurations;

FIG. 2C shows discrete sub-laminate components or elements of a wing according to conventional configurations;

FIG. 3A, representative of prior art, shows one master-ply stiffness component of all of the sub-laminates within the double-double sub-laminate family;

FIG. 3B, representative of prior art, shows two three-dimensional representations of the double-double sub-laminate family at angle increments of 10 and 2 degrees, respectively;

FIG. 3C, representative of prior art, shows aligned charts identifying viable replacements within the double-double sub-laminate field for anchors within the legacy quad sub-laminate field;

FIG. 4 demonstrates that the short fiber or ply double-double composite laminate structures exhibit near comparable tensile strength and modulus characteristics when compared with continuous fiber or ply constructions;

FIG. 5 provides example slit patterns and the resulting formable shapes.

Additional details regarding various features illustrates within the figures are described in further detail below.

### DETAILED DESCRIPTION OF VARIOUS EMBODIMENTS

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### Conventional Laminate Characteristics

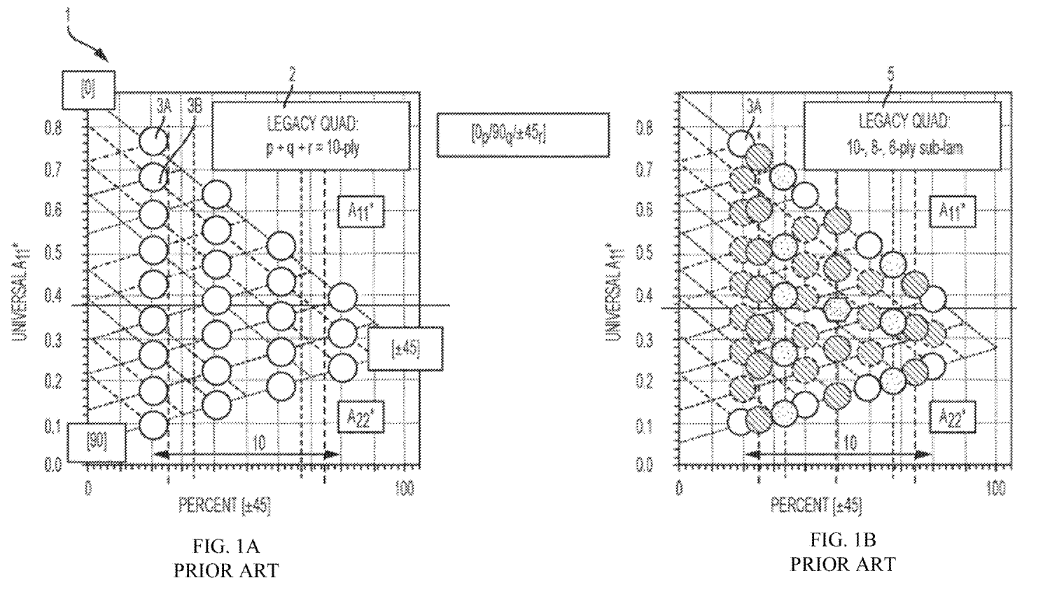

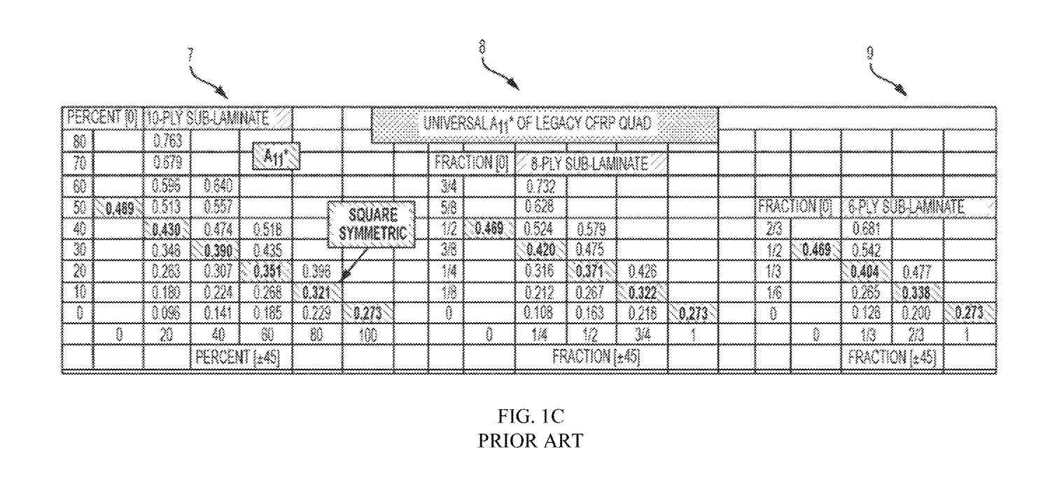

As mentioned previously herein, conventional legacy quad laminates were made of collections of [0], [±45] and ply configurations. These laminates were discrete and not possible to interpolate due to a variety of self-inflicted constraints (e.g., fixed angles, symmetry, etc.). To have more directional properties, plies had to be added to their sub-laminates, which in turn increased weight and decreased design flexibility of laminate structures due to thickness. Nevertheless, to achieve somewhat desirable material characteristics of legacy laminates, necessarily at least 6-, 8- and 10-ply thick (and oftentimes thicker) sub-laminates were utilized. When laminates with mid-plane symmetry are required and met, their thicknesses with 6- to 10-ply sub-laminates would be doubled, tripled or more. Such thick sub-laminates were, in addition to being undesirably heavy in weight, delamination prone, which also made blending, ply drop, and ply layup difficult; still further material characteristics could oftentimes not be optimized (to, for example, desired characteristics) due to limitations imposed by the discrete number of ply configurations available in the field (see field 1 illustrated in FIG. 1A). As a result, there are gaps between laminate stiffness and strength that cannot be bridged using conventional legacy quad laminates. Multiple failure modes and complexity in manufacturing thus existed.

These various considerations involved with conventional legacy quad laminates may be understood with reference again to FIG. 1A, wherein the legacy quad field 1 for a 10-ply thick sub-laminate 2 is illustrated. Once more, conventional nomenclature is utilized as [0p/90q/±45r] to identify the sub-laminate, wherein p represents the number of 0° ply layers, q represents the number of 90° ply layers, and r represents the number of ±45° ply layers. In the specific example illustrated 10 total plies are provided. In example discrete sub-laminate 3A, the sub-laminate is formed with 80% 0° ply layers, 20%±45° ply layers and no 90° ply layers (i.e., for the 10-ply configuration illustrated, eight 0° ply layers, two ±45° ply layers and no 90° ply layers). Another discrete sub-laminate 3B is also highlighted, wherein the sub-laminate is formed with 70% 0° ply layers, 20%±45° ply layers and thus 10% 90° ply layers (i.e., for the 10-ply configuration illustrated, seven 0° ply layers, two ±45° ply layers and one 90° ply layers). As another non-limiting example, if stiffness with 80% 0°, 10% 90° ply and 10%±45° ply is desired, the sub-laminate will have to be 20 ply thick. Remaining characteristics for the other discrete twenty-four (24) sub-laminates available (i.e., each dot or anchor in FIG. 1A) may be extrapolated from these examples.

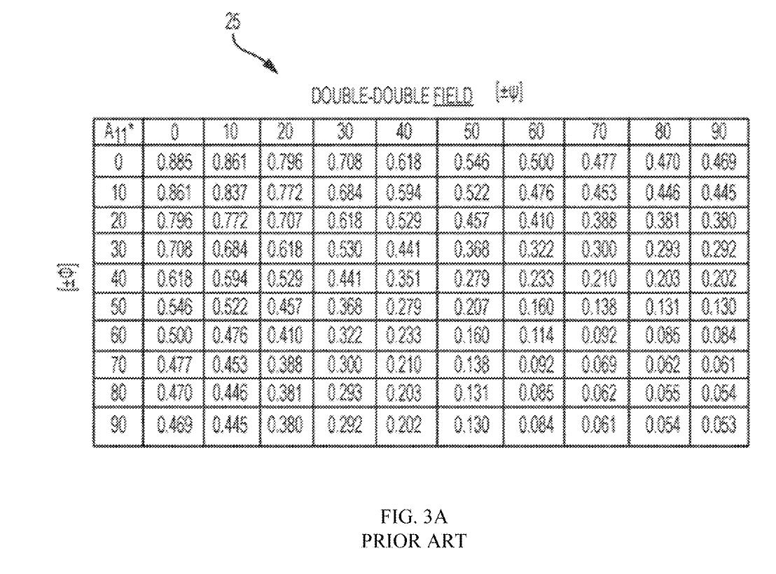

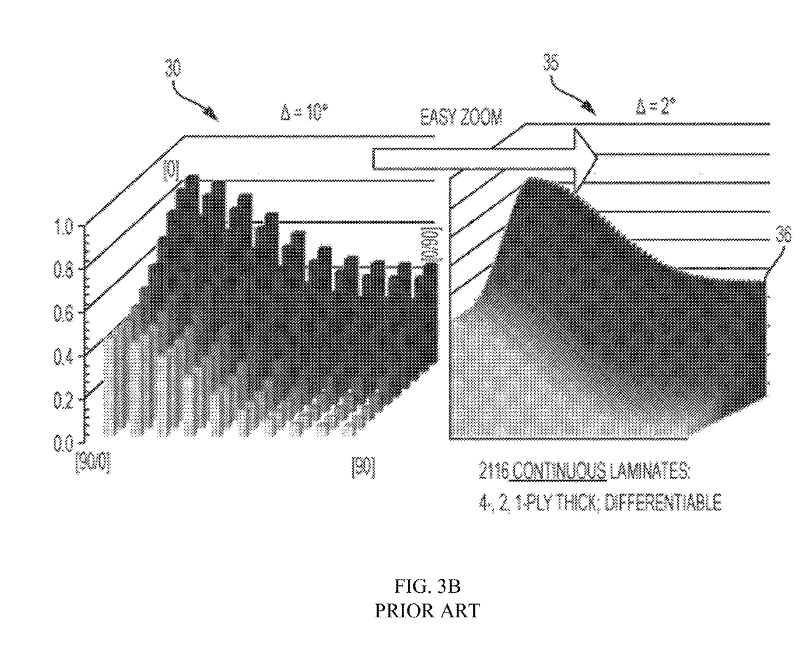

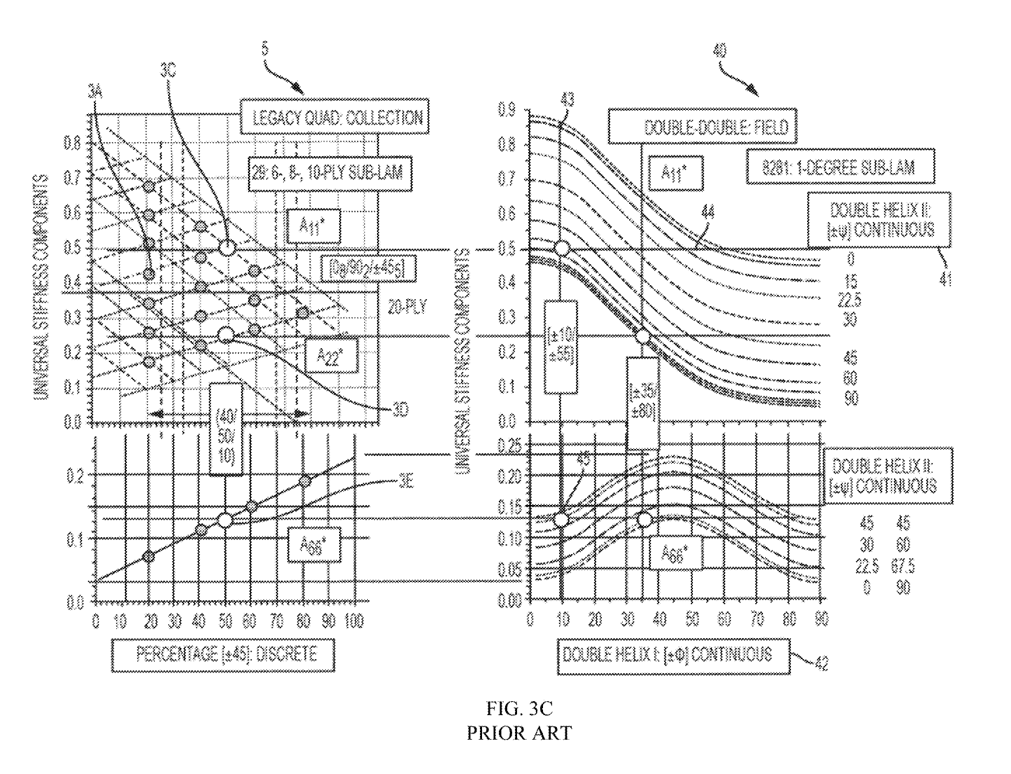

With reference now to FIG. 1B, relative to the 10-ply legacy quad field 1 illustrated in FIG. 1A, populated therein also are the discrete sub-laminates achievable (indicated by the discrete dots or anchors shown) with not only a 10-ply sub-laminate, but also with associated 6-ply and 8-ply configurations (i.e., a combined 10-, 8-, and 6-ply configuration 5). Thus, it may be understood that—even with the 6-, 8-, and 10-ply conventional legacy quad sub-laminate structures—a total field of only forty-seven (47) laminates was achievable (see again, FIG. 1B; see also FIG. 3B). Notably, though, holes remain visible between the respective discrete sub-laminate structures (i.e., although some of the dots or anchors 6 may partially overlap one another, not all of the dots or anchors 6 fully overlap with each other and thus fill all of the visible space in the field); as a result, achieving certain desirable material characteristics remains challenging and many times simply unachievable (again, due to the various self-inflicted constraints on conventional legacy quad field sub-laminates having different thicknesses in 6 to 10-plies that make blending and ply drop so complicated).

FIG. 3B provides three-dimensional and alternative views of the same discrete forty-seven (47) laminates 16 achievable via conventional legacy quad sub-laminate structures. As may be understood therefrom, as alluded to above, holes remain visible between the respective discrete sub-laminate structures that are achievable. No derivatives or continuous slopes (as will be detailed elsewhere herein) may be obtained; still further, the degree of discreteness cannot be zoomed to smaller increments, such that a continuous field may be obtained; instead, conventional legacy quad sub-laminate structures are restricted—at least in the instances of 10-, 8-, and 6-ply thick structures—to the discrete increments illustrated. Thus, to reiterate, obtaining of certain desirable material characteristics may remain challenging and many times unachievable. This may be understood also with reference to FIG. 3A and the complete chart of stiffness values for the legacy quad collection 15 illustrated therein (compare with FIG. 1C, described below and showing a subset thereof). Therein, the horizontal axis depicts percentage of ±45° plies in the laminates. As stated earlier, with the legacy quad family, many percentages cannot be achieved with 10 or less plies in the sub-laminates. The case of 10 percent ±45° will require 20 plies in the sub-laminate. Such ultra-thick sub-laminates are not practical.

FIG. 1C depicts a set of three charts, namely illustrating a sub-set of the values of one stiffness component A11* with respect to the 10-ply sub-laminate 7 of FIG. 1A, the 8-ply sub-laminate 8 of FIG. 1B, and the 6-ply sub-laminate 9 of FIG. 1B. As may be understood from these respective charts, the sub-laminates exhibit the greatest stiffness (i.e., the highest stiffness values) where the highest percentage of 0° ply layers are used. For example, in the subset illustrated in FIG. 1C, the stiffness value (0.763) is highest for the 10-ply sub-laminate where 80% 0° ply layers are used, accompanied by 20%±45° ply layers. Another notable example, is the stiffness value (0.321) of a “square symmetric” sub-laminate having 10-ply layers, with the “square symmetric” nomenclature accompanying 10% 0° ply layers are used, accompanied by 80%±45° ply layers representing that equal stiffness exists along both the x- and the y-axes of any so defined sub-laminate module or structure. This class of sub-laminates is particular useful, due to its having exact replacement of a legacy quad by double-double. For non-square symmetric laminates the replacement is nevertheless still an approximate match.

Reference will be made to FIG. 1C elsewhere herein (see also analogous FIG. 3A, illustrating complete collection 15 of 10-ply legacy quad configuration stiffness values—see again 0.763 stiffness value for where 80% 0° ply layers are used, accompanied by 20%±45° ply layers), by way of useful comparison to charts of stiffness values for double-double laminate structures. Via the comparison thereof, optimization opportunities via various embodiments of the present invention may be best understood. It should also be understood, from FIG. 3A, that stiffness values for the illustrated legacy quad collection may also be readily calculated using the formula of % of [0]*0.886, wherein the 0.886 represents the stiffness value when 100% [0] ply layers are used and/or the formula of % of [±45]*0.274, wherein the 0.274 represents the stiffness value when 100% [±45] ply layers are used. Notwithstanding, holes remain, such that, were a stiffness of 0.750 desired, designers would be forced—unless will to sacrifice potentially important material characteristics—to overdesign to 0.763, achieved with 80% [0] plies and 20% [±45° ].

The collection 15 of FIG. 1C is also informative in terms of guidance of the laminate design without use of sub-laminates, as mentioned previously herein. As a non-limiting example the entire laminate may be designed to satisfy the percentages of the quad ranges in 0°, ±45° and 90°. Beyond the requirements of symmetry and ply grouping to larger than three (again, as mentioned previously herein), every ply stacking selection is subjective, meaning there is no scientific or mathematical analysis involved, but for having well dispersed plies that would facilitate ply drop and blending. Unfortunately, this approach often leads to multiple internal fiber discontinuities, ply wrinkling, and other defects that can be sources of multiple damage initiation sites. Double-double laminates and sub-laminate structures, in contrast, achieve structures having no internal defects, where, for example all ply drops are positioned on one of the outer surfaces. In this context, having thin sub-laminates with constant thickness makes blending, ply drop, and manufacturing much simpler than the quad laminates in one piece or in thick sub-laminates.

Notably, though, throughout the above discussion and illustrations it should be understood that the core problem of the legacy quad laminate design is that all sub-laminates are discrete. As a result, even with utilization of 6-, 8-, and 10-ply configurations, there are no comprehensive connections among all 47 members in the sub-laminate. Thus, beyond the remaining “holes” where certain material characteristics may remain unachievable, blending between different laminates (i.e., from adjoining elements) has no standard solution. This is because there is no continuous connection between the two different laminates, for example where each laminate is a different discrete configuration. There will be thousands of fiber discontinuities inside each laminate. They are the sources of multiple failures under static and fatigue loading. Tapering is also difficult due to the lack of continuity. As a result, laminated structures using legacy quad oftentimes cannot be optimized with respect to material characteristics, and ply stacking (including tapering and blending) is extremely complicated, making automated layup procedures not only costly, but also necessarily involving compromises in material characteristics and thus structural integrity, possibly leading to multiple material failure modes that are not possible to predict (at least in part due the complexities and uncertainties involved between the discrete dots or anchors).

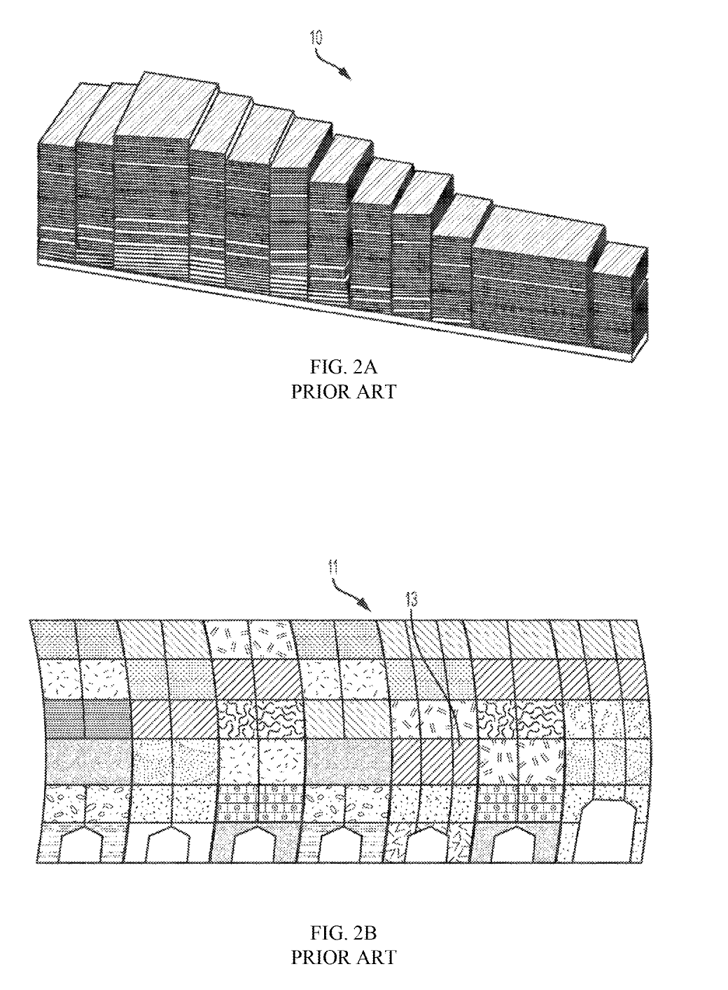

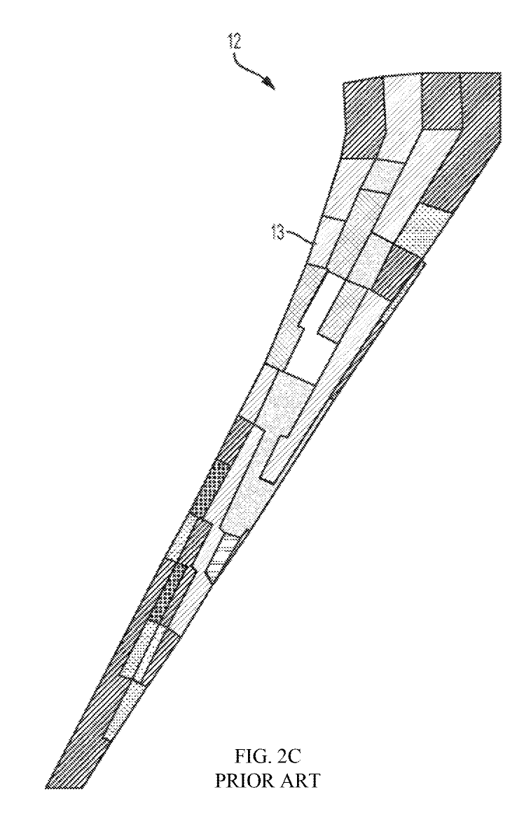

An example in this respect proves informative, with reference to FIGS. 2A-C, wherein examples of discrete elements 13 are illustrated, both in a fuselage 11 (see FIG. 2B) and a wing 12 (see FIG. 2C). According to conventional configurations, each element by itself is constructed from its own sub-laminate structure, largely so as to provide for that discrete area of the fuselage or wing desired material characteristics therefor (e.g., to maximize stiffness or the like). To blend these different and discrete elements 13 into one continuous structure (e.g., a fuselage 11 or a wing 12) is, however, a huge challenge when legacy quad laminates are used. This is, again, due to all of the laminates therein being discrete and having differing sub-laminate thicknesses (i.e., 10-, 8-, or 6-ply configurations) and also different collections of 0°, ±45°, and 90° plies, as detailed previously herein (i.e., both thickness and ply set collections are variable constraints so as to achieve the forty-seven (47) discrete options for legacy quad (see again FIGS. 1A-B; see also FIGS. 3A-B, as detailed elsewhere herein). One element may have 3 plies of 0° ply while the adjacent elements have 5 plies of 0° ply, to blend or bridge this gap is to create a transition zone of 4 plies or a big drop of 2 plies. In either case, the complexities in blending among elements make laminate weak, not optimized, and difficult to manufacture. In addition, blending conventionally also has to be done in both x- and y-direction.

Within the above example, despite and in part because of the availability of forty seven (47) discrete sub-laminate configurations, traditional optimization techniques to achieve desired stiffness, desired tapering by ply drop, desired ply angle alteration, and/or desired strength characteristics are not workable. Where tested, multiple ply angle and/or ply layer discontinuities arise, as may be understood from the final stacking 10 of discrete sub-laminates along a wing 12 (see FIG. 2C). From viewing FIGS. 2A and 2C in combination, it may be understood that a brick-like and patchy layer is the best achievable—variable in material characteristics and thicknesses alike—which as a result presents complexities oftentimes unable to be overcome, where prediction of structural strength and/or stiffness (i.e., generally material characteristics) is critical. Unknown and many potential internal failure modes exist, which modes can lead to delamination, micro-cracking, and/or fiber failure in multiple locations along a structure (i.e., a fuselage 11 or a wing 12). And unfortunately, conventional structural analysis cannot predict all of these potential failure modes or provide guidance or instructions for optimal ply drop, weight savings, and/or laying/stacking sequence. As a result, finished structures (i.e., fuselages 11 or wings 12) may be compromised structurally and not achieve—throughout—all desired design goals.

### DOUBLE-DOUBLE LAMINATE CHARACTERISTICS

The continuous field of double-double sub-laminate structures described herein (see, as previously developed, with reference to FIGS. 3A-C-C described herein-above) achieves sub-laminates with at most 4-ply thick structures; even thinner 2- and 1-ply thick configurations are obtainable. Throughout various embodiments, the ply angles are also continuous, making blending of different laminates and their optimization achievable. Sub-laminate thickness remains constant. For directional property, the angles of each double helix can change continuously to the desired values. Plies are not added like the case of legacy quad family. As a result, far fewer failure modes (and virtually no unpredictable failure modes) are encountered, and automated layup procedures may be conducted in relative simplistic fashions. All of these and still other advantages lead to much simpler and lighter structures that are also better optimized for purposes of efficiency and accuracy, notably improvements given that the further above-detailed degree of uncertainty with conventional legacy quad laminate structures is becoming ever-increasingly unacceptable across multiple industries. Having thinner sub-laminates (4 of less versus 12 to 20) the minimum gage requirement is lowered. Many electronic and medical devices can now use composite laminate. This is not possible if laminates must be multiples of 12 to 20 plies.

### Originally Utilized Stacking Sequence

FIG. 3C further illustrates the manner in which the degree of granularity involved in forming each collection of continuous double-double sub-laminates is potentially indefinite, whereby here there is illustrated a continuous field 40 (see right-hand chart), produced with angle increments of 1°. This field results, as illustrated in the right-hand chart of FIG. 3C, in a double-double laminate field 40 that contains 8,281 sub-laminate structures from which to choose, each having distinctive material characteristics associated therewith. It should be understood that the illustrated angle increments in these figures(e.g., 10°, 2°, 1°) are non-limiting examples; in view of the derivative nature of the double-double sub-laminate field (as detailed elsewhere herein), any angle increment can be selected, depending upon the degree of granularity that may be necessary to obtain a viable stiffness or strength match (as also detailed elsewhere herein) to a conventional laminate structure and/or sub-laminate structure. In this manner, the double-double sub-laminate fields 30, 35, 40 should be understood as indicative of a continuous field of selectable ply angle and ply layer configurations, so as to best match conventional laminate structures having much greater thicknesses and/or to fill gaps of strength or stiffness values in such conventional structures due to the limited set of 47 discrete values under legacy quad-type configurations, as described previously herein.

Returning now to FIG. 3B, a continuous field of laminates [±Φ/±Ψ] (see FIG. 3C as well, illustrating the discrete and independent [±Φ] 42 and [Ψ] 41 ply angle sets) is provided for selection therefrom, as contrasted with the discrete legacy quad collections (i.e., 47 options versus double-double's 8,281+potential options). Zooming to achieve higher resolution (i.e., granularity) is conceptually easy via various embodiments of the double-double sub-laminate described herein and is shown on the right side of FIG. 3B. Equally important with granularity and this continuous field is the advantage that the sub-laminate thickness remains constant, at most being 4-ply; 2- or 1-ply configurations are, however, also possible if folding is incorporated. Stiffness values may thus be also changed in a continuous fashion (i.e., no holes or gaps), simply by changing the angles within the continuous field. Notwithstanding this flexibility and opportunities for optimization associated therewith, a remaining constraint for purposes of homogenization and achieving specifically desired material characteristics of formed laminates remained the discrete stacking sequence, whereby specific ply angle sets were required. These ply angle sets, referenced generally as [±Φ] 42 and [Ψ] 41 resulted in laminate and sub-laminate structures having limitations as to the sequence of the discrete plies when stacked relative to one another.

Multiple angled laminated composite structures (i.e., tape) exhibit desirable stiffness and strength when the thermally cured laminate is flat or planar (i.e., it is not curved or bend during formation). This is true not only with conventional structures, but also with the double-double, thin ply or tape, constructions (laminates and/or (sub)modules thereof defined by specific orientation and numbering of plies therein). Conventionally, when curvatures have been required, localized shortened tapes were provided; however, these were limited to narrow (longitudinal) and/or quasi-isotropic constructions and/or orientations. Not only did this limit flexibility and forming (i.e., curves were localized and drastic versus gradual), the process for lamination of these narrow and restrictive tapes is known to be costly and time consuming.

By way of contrast, embodiments of the present invention involve pre-plied double-double (PPDD) tape or laminate structures (including (sub)modules thereof, sometimes referred to as ‘building blocks’). Specifically, the PPDD building blocks are achieved by breaking continuous PPDD tape or plies/modules. The breaking may be achieved via a cutting assembly, whereby an existing DD tape or building block can be reduced in length uniformly and/or in a zoned manner. Stated otherwise, only a portion of the existing DD tape or building block may have plies therein broken or cut. This may be exemplified in an exemplary process, whereby instead of per se cutting, the shortened fiber portions (in part or in entirety) are achieved by a stretching (or imposition of a force upon) the existing DD tape or building block, to a point at which failure (i.e., breakage) of the fibers occurs. As an example, a plurality of plies may be stretched until a stress-induced breakage occurs, resulting in the shortened length of a portion of the plurality of plies. Such shortened length may be a length shorter than a length of a conventional plie in a correspondingly structure module. A conventional plie may be a conventional double-double technology or a conventional tape with a thickness of at least 120 GSM. Comparatively, while per se cutting enables precise determination and obtaining of specific length fibers, as may be desirable in certain commercial applications (as detailed elsewhere herein), the stretch failure approach may result in fibers of shortened, but differing lengths. In the latter, it is noted that the failure point defining the length of the shortened fibers or plies eliminates and/or substantially minimizes the risk of any low strength/low resilient areas being within the remaining length of the fibers or plies.

As mentioned, the PPDD buildings blocks and/or the short fiber plies therein are an extension (or improvement) upon conventional double-double technology which may be understood with reference to US Publication No. 2021/0114336 and US Publication No. 2022/0297407, the contents of which as are hereby incorporated herein by reference in their entirety.

The PPDD building blocks are further particularly effective when thin ply constructions are utilized, whereby weights as low as 20 GSM may be achieved for a single ply – resulting in a building block (i.e., with 4 plies) having only 80 GSM. With extra thin plies/tapes and resulting building blocks, composite skins can be built with single-axis layup (cross-plying no longer needed), lower minimum gauge applications are feasible, and aggressive taper to save costs/weight are possible. Conventional tape or rather conventional plies, by way of comparison, has at least a thickness of 120 GSM or higher, with difficulties in terms of any tapering thereof.

Specific cut lengths of the PPDD building blocks, and particularly the short fiber plies therein, are advantageous in that the challenge of breaking fiber into a uniform field with a staggered pattern can be overcome. This is achieved, at least in part, by having cutting tools (i.e., knives) spaced in a fixed pattern so that successive cutting can generate similar fiber break patterns. In certain embodiments, the staggered break patterns may shorten by one half lengths of the broken fibers; of course, alternative stagger shortening (i.e., greater or less than one half) may also be utilized. As an example, though, if the cutting tools are spaced so that the short fiber is 12 mm in length, the second run spaced at the midpoint can lead to a fiber that is 6mm in length; a third run would have short fiber in 3mm lengths; and so forth. In this manner, the shortened length fibers may not only be variable as to whether they’re blended or only partially provided in a PPDD building block or the like, but the lengths thereof may also be varied – intentionally or randomly (as below, with breaking point or stretch ‘cutting’). Further, the short fiber lengths may be a function of fiber orientation, with respect to which the entire field of double-double (sub) modules and/or (sub) laminate constructions are available. This provides formability of each PPDD that can be precisely calibrated—to the extent desirable, achieving a balance between the shortened fiber or ply density (as measured by length) and resulting laminate properties (i.e., strength, formability, stiffness, and the like, as detailed elsewhere herein).

Post-formation of the PPDD building blocks and/or short fiber plies described herein, realignment thereof may be achieved in any of a variety of ways, including for example via utilization of a centrifuge process. In such processes, utilization of thin-ply constructions is important, facilitating alignment of the shortened fibers for compiling thereof into composite laminate structures derived from the PPDD building blocks or otherwise. Of course, additional or alternative processes may be utilized—as conventionally known—to achieve desired realignment of the shortened length fibers or plies. Another example involve fluid flow imposed upon the broken, chopped, or cut fibers. The pre-plied construction further facilitates direct placement of the construction in a formable mold direction, with no need for cross-plying; provision of different layers to have taper skin to save further weight and cost is also achievable. This may all be contrasted with unidirectional tape or plies, wherein such flexibility of formation is not feasible.

The PPDD building block (whether as module or (sub)laminate structure) can be made of various materials, including, by way of non-limiting example, non-scrimp fabric with thin plies (75 or 50 or 25 or even 20 GSM) or otherwise. With thin plies, as defined, a thickness of the PPDD building block may be a fraction of a millimeter. As a result, ply drops, homogeneity, tensile strength, stiffness, and other desirable material properties are achievable with values comparable to conventional constructions, but with less material, weight, and/or volume. Of course, construction may be, in part or in whole, with non-thin plies or otherwise, as may be desirable.

Potential commercial applications include utilization of sub-laminate modules and/or composite laminate structures formed therefrom and having shortened length fibers or plies therein for at least: wind turbine constructions, particularly for the blades thereof; curved automotive parts or components (such as a curved automotive panel), internal or externally facing; engine blades, whether automotive and/or larger scale for airline/airplane constructions (such as a curved wing panel); helicopter rotor and blade constructions, and more. Advantages may include, as non-limiting examples, maintained and/or improved material strength, stiffness, or other characteristics considered desirable with less material and less thickness. For aviation-related applications, thin-ply constructions achieve improved bird (or other obstacle) strike resistance, for a fraction of the cost and weight.

Further potential commercial applications may also exist on a microscopic level, including for example the ability to construct curved and/or formable parts in the semiconductor, chip, and/or processor (computer, portable device, cellular device, and the like) industries. Curved and/or formable platforms for batteries (i.e., circular-shaped or otherwise) may also be achieved given the combination of strength and stiffness – but also formability—of the PPDD building blocks described herein. Still further potential commercial applications include electronics, medical devices, consumer products, particularly those involving plastic parts made with sheet molding compound (i.e., chopped glass or carbon laminates with quasi-isotropic properties) that are conventionally very low in mechanical properties. Replacement of such materials with the PPDD building blocks and/or the shortened fibers or plies contained therein will provide strength and stiffness that near matches, matches, and/or exceeds conventional constructions—with a fraction of the weight and while being more moldable in form.

Uniqueness of the various embodiments described is that moldable or formable into non-planar or non-flat shape PPDD structures or (sub)modules are achievable. Pre-plying permits a single-axis layup, achieving more than 6x greater efficiency in manufacturing and assembly of the structures. Wide tape (up to one meter) is also achievable, as compared to conventional limitations that restrict width, at times, to twelve inches. Fluid flow and centrifugal processes are suitable, further with the use of thin plies, as defined elsewhere herein. Tapering, reduced minimum gauge, lower cost, lighter weight, and the like are also facilitated with constructions not previously observed.

Further, in certain embodiments of the present invention a correlation between the percentage (by weight, volume, or otherwise) of short or shortened fibers or plies within a PPDD building block and formability and/or moldability is provided thereof. Specifically, the greater and/or more evenly distributed the amount and/or number of short or shortened fibers or plies present, the greater the formability. This, amongst other advantages, results in the ability to utilize the PPDD building blocks (and associated structures) in the layup of complex curvatures, such as helmets, spherical domes, and/or local ridges in automotive (or other vehicular) panels. Wrinkles, and/or a propensity toward wrinkling is thus minimized and/or substantially eliminated due to use of the short or shortened fibers or plies. Calibration can occur between the length of the short or cut fibers with formability, including adjustment of length and/or provision of variable lengths of short or cut fibers or plies within a single sample. Internal discontinuities are also thus avoided.

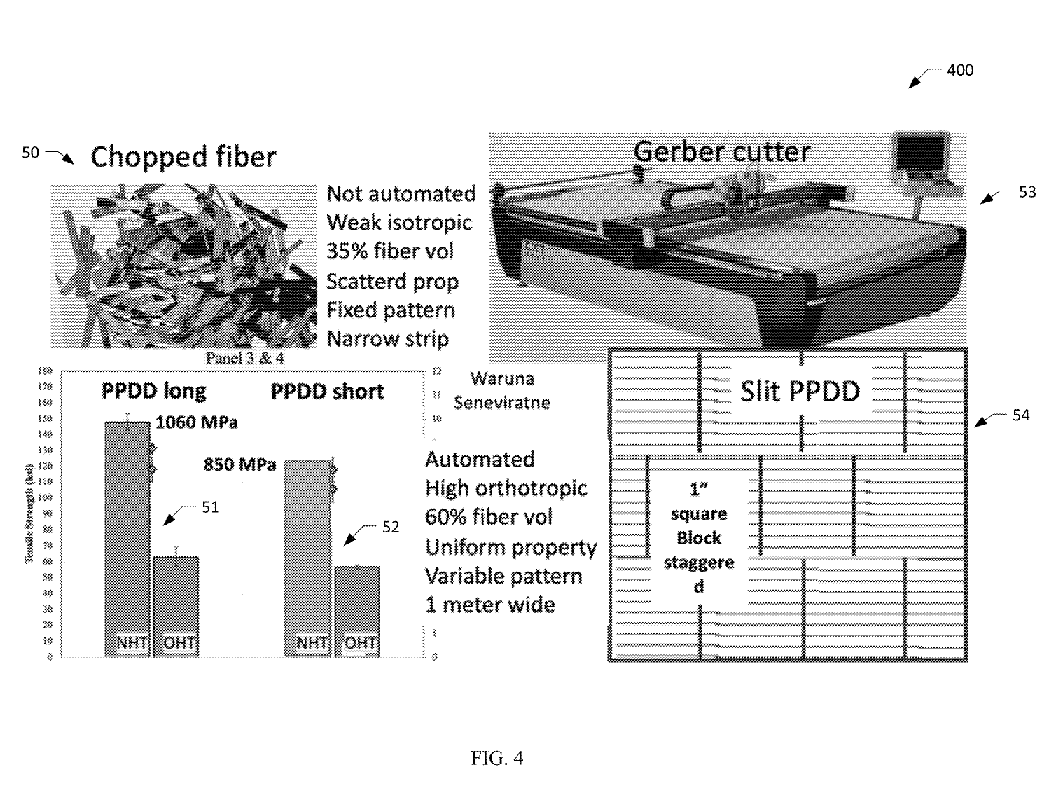

Referring now to FIG. 4, exemplary test data is provided accordingly embodiments of the present invention. The exemplary test data demonstrates that the short fiber or ply double-double composite laminate structures exhibit near comparable tensile strength and modulus characteristics (see FIG. 4, 51) when compared with continuous fiber or ply constructions (See FIG. 4, 52). This is particularly true in the instance of tests conducted with an “open hole” construction (i.e., open hole tension (OHT) tests) versus tests conducted with no holes in the samples (i.e., NHT or no hole tension tests). For example, values between 50-60 ksi—and near 60ksi—are observed for both test samples, demonstrating surprising and/or unexpected results given the shortened (i.e., broken or cut) length of the fibers, as compared to continuous (and expected much stronger) fiber structures. For example, as shown in FIG. 4, the shortened (i.e. broken or cut) fibers are cut using a Gerber cutter 53. The Gerber cutter 53 is configured to cut the continuous fibers to a shortened length of the fiber using the pattern 54. The pattern 54 is a 1 inch square block staggered pattern.

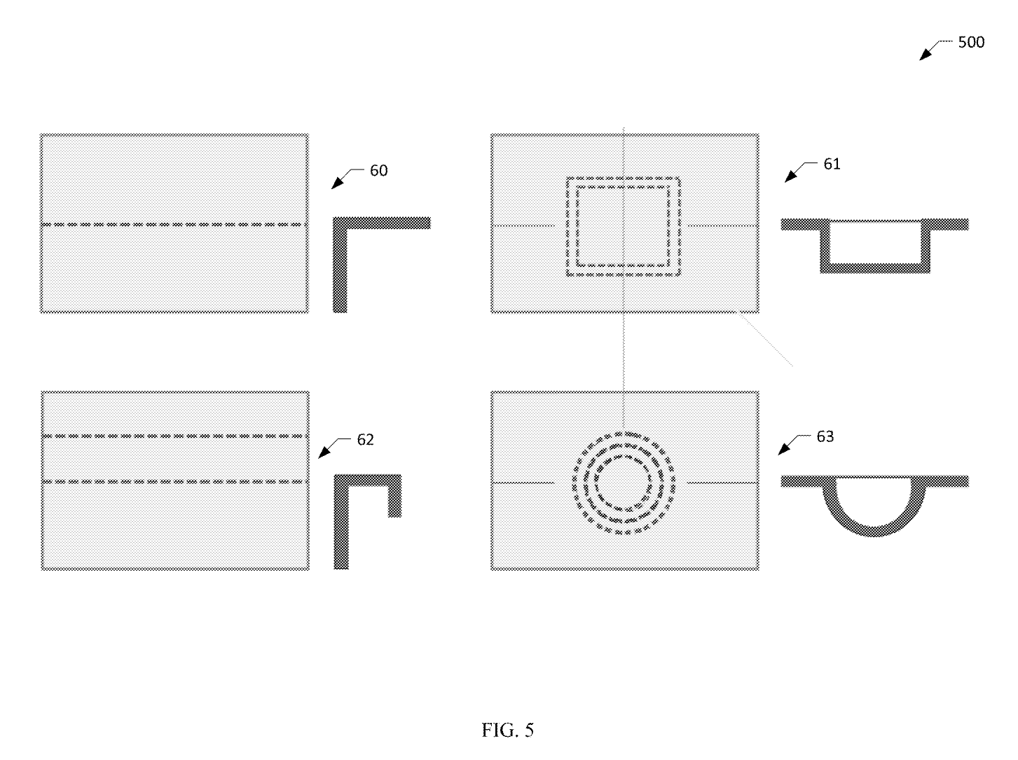

Now referring to FIG. 5, example slit patterns are provided and their resulting formable shapes. For example, pattern 60 is a singular slit positioned horizontally across the fiber. This results in an “L” shape. The “L” shape comprises a vertical portion extending downward along a first direction, and a horizontal portion extending laterally from an upper end of the vertical portion along a second direction that is generally perpendicular to the first direction. As another example, pattern 61 is a square cut in the center of the fiber. As shown in the figure, the illustrated structure resulting from pattern 61 defines a recessed channel formed within a body. The structure includes an upper horizontally extending portion and a lower recessed portion defining a generally U-shaped section. As another example, pattern 62 comprises two parallel slits which result in an r-shape formed by two elongated, rectilinear portions joined at a right angle. The r-shaped comprises a vertical leg extending downward along a first direction, and an upper horizontal leg extending laterally from an upper end of the vertical leg along a second direction that is generally perpendicular to the first direction. As another example, pattern 63 is a circular slit pattern that results in a generally semicircular shape that includes an upper horizontal member extending laterally along a first direction, and a curved downward extension projecting from a central region of the upper horizontal member.

Of course, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A composite laminate structure comprising:
a plurality of sub-laminate modules, wherein each of the plurality of sub-laminate modules comprises:
a set of ply layers having a plurality of plies contained therein and oriented at different angles relative to a longitudinal axis of each of the plurality of sub-laminate modules, wherein at least a portion of the plurality of plies have a length that is shorter than a length of conventional plies in a correspondingly structured module.

2. The composite laminate structure of claim 1, wherein the composite laminate structure is part of a curved automotive panel.

3. The composite laminate structure of claim 1, wherein the composite laminate structure is part of a curved wing panel.

4. The composite laminate structure of claim 1, wherein the plurality of sub-laminate modules and the plurality of plies therein are positioned in a non-crimped fiber configuration.

5. The composite laminate structure of claim 1, wherein the plurality of plies therein are pre-plied.

6. The composite laminate structure of claim 1, wherein at least a portion of the plurality of plies is cut to a shortened length.

7. The composite laminate structure of claim 6, wherein to cut at least a portion of the plurality of plies, the plurality of plies is stretched until a stress-induced breakage occurs, resulting in the shortened length of the portion of the plurality of plies.

8. The composite laminate structure of claim 1, wherein the composite laminate structure is suitable for use in forming a blade.

9. The composite laminate structure of claim 8, wherein the blade is part of one of a wind turbine, a helicopter rotor assembly, or an automotive or airplane engine.

10. A method for forming a composite laminate structure comprising cutting a portion of a plurality of plies to a shortened length.

11. The method of claim 10, wherein cutting the portion of the plurality of plies comprises stretching the plurality of plies until a stress-induced breakage occurs resulting in the shortened length of the portion of the plurality of plies.

12. The method of claim 11, wherein the shortened length of the portion of the plurality of plies may comprise fibers of differing lengths.

13. The method of claim 10, wherein cutting the portion of the plurality of plies comprises imposing a force upon the plurality of plies resulting in the shortened length of the portion of the plurality of plies.

14. The method of claim 13, wherein the method further comprises spacing cutting tools in a fixed pattern to generate similar fiber break patterns.

15. The method of claim 14, wherein the similar fiber break patterns may comprise a staggered break pattern or an alternative stagger shortening break pattern.

16. The method of claim 15, wherein the staggered break pattern results in a portion of the plurality of plies shortened by one half length of a length of conventional plies.

17. The method of claim 15, wherein the alternative stagger shortening break pattern results in a portion of the plurality of plies greater or less than one half of a length of conventional plies.

18. A sub-laminate module comprising:
a set of ply layers having a plurality of plies contained therein and oriented at different angles relative to a longitudinal axis of the sub-laminate module, wherein at least a portion of the plurality of plies have a length that is relatively shorter than a length of conventional plies in a correspondingly structured module.

19. The sub-laminate module of claim 18, wherein a first portion of the plurality plies have a length substantially less than a length of a second portion of the plurality of plies.

20. The sub-laminate module of claim 18, wherein the plurality of plies therein are pre-plied.
